(19) United States
(12) Patent Application Publication
(10) Pub. No.: US 2024/0191548 A1
(43) Pub. Date: Jun. 13, 2024

(54) Door Barrier Device

(71) Applicant: James Healey, Tucson, AZ (US)

(72) Inventor: James Healey, Tucson, AZ (US)

(21) Appl. No.: 18/522,399

(22) Filed: Nov. 29, 2023

Related U.S. Application Data
(60) Provisional application No. 63/430,874, filed on Dec. 7, 2022.

(51) Int. Cl. E05C 19/18

(52) U.S. Cl. CPC E05C 19/188

(57) ABSTRACT

A door barrier device is provided. The device is comprised of comprised of at least one guide rail that can be attached to a door and a floor plate that can be attached to a floor surface below the guide rail. A plate (preferably made from steel) can then be inserted through the guide rail and into the floor plate (and/or through the floor plate and into the floor surface in one embodiment) to prevent the door from being pushed/kicked open by reinforcing the door. In one embodiment, the plate may also be made from a bulletproof material to further protect a user behind the door.

### CROSS-REFERENCE TO RELATED APPLICATION

The present application claims priority to, and the benefit of, U.S. Provisional Application No. 63/430,874, which was filed on Dec. 7, 2022, and is incorporated herein by reference in its entirety.

### FIELD OF THE INVENTION

The present invention relates generally to the field of door barriers. More specifically, the present invention relates to a door barrier device that is comprised of a guide rail that can be attached to a door and a floor plate that can be attached to a floor surface below the guide rail. A plate can then be inserted through the guide rail and into the floor plate (and/or through the floor plate and into the floor surface) to prevent the door from being pushed/kicked open. Accordingly, the present disclosure makes specific reference thereto. Nonetheless, it is to be appreciated that aspects of the present invention are also equally applicable to other like applications, devices, and methods of manufacture.

### BACKGROUND

Home break-ins and acts of vandalism are not only distressing but can also pose significant threats to the safety and well-being of residents. In many instances, individuals find themselves with minimal time to react when faced with an unexpected intruder, leaving them vulnerable and in potential danger. While one might hope that law enforcement would be on the scene immediately, the reality is that there can be delays in their response. This lag in time can lead to devastating consequences, including severe injuries to the occupants and substantial property damage or loss.

One of the primary concerns is the structural integrity of standard doors found in most homes. These doors, often designed more for aesthetics than security, are typically ill-equipped to withstand forceful entry attempts. Constructed predominantly from wood, both the door and its frame have inherent limitations. Wood, being an organic material, has a threshold to the amount of pressure it can endure before it gives way or fractures. This makes it relatively easy for determined intruders to breach such barriers in a short span of time. Moreover, most conventional doors offer little protection against firearm penetration. Bullets can easily penetrate these doors, further compromising the safety of those inside.

Therefore, there exists a long-felt need in the art for a device that increases the strength of a door. More specifically, there exists a long-felt need in the art for a door barrier device. There also exists a long-felt need in the art for a door barrier device that strengthens a door and prevents it from being easily kicked in. In addition, there exists a long-felt need in the art for a door barrier device that prevents a bullet from penetrating a door. Further, there exists a long-felt need in the art for a door barrier device that strengthens a door and prevents the door from being easily kicked in and prevents a bullet from penetrating a door, wherein the device can be applied to any door.

The subject matter disclosed and claimed herein, in one embodiment thereof, comprises a door barrier device. The device is comprised of comprised of at least one guide rail that can be attached to a door and a floor plate that can be attached to a floor surface below the guide rail. A plate (preferably made from steel) can then be inserted through the guide rail and into the floor plate (and/or through the floor plate and into the floor surface in one embodiment) to prevent the door from being pushed/kicked open by reinforcing the door. In one embodiment, the plate may also be made from a bulletproof material to further protect a user behind the door.

In this manner, the door barrier device of the present invention accomplishes all the forgoing objectives and provides a device that increases the strength of a door. More specifically, the device prevents a door from being easily kicked in. In addition, the device also prevents a bullet from penetrating a door. Further, the device can be universally installed on any door via the guide rails.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a door barrier device. The device is comprised of at least one plate that attaches to a door via at least one guide rail, wherein the bottom edge of the plate is also received by at least one floor plate mounted within the floor surface near the door. The plate further falls into an opening of the plate and into the floor surface such that a portion of the plate is secured in the surface. As a result, the door is reinforced and cannot be easily opened with the plate in place.

The plate is preferably made from a metal material such as but not limited to 14 gauge steel. In one embodiment, the plate may be made from a bulletproof material. The plate is received by at least one guide rail that attaches to a front or rear surface of a door. The rail is comprised of at least one plate opening that preferably runs the duration of the rail and begins on the top wall of the rail. As a result, the side edges of the plate can be placed through the opening from above to allow the plate to slide into the rail. To prevent the plate from sliding completely through the rail, the top edge of the plate is comprised of at least one 90-degree angle that forms a lip.

After the plate is positioned in the mounting opening of the guide rail, the bottom edge (and some portion of the side edges) may be received by at least one opening of at least one floor plate. The floor plate is preferably positioned below the opening of the rail. The plate is preferably installed in a recessed manner within the floor surface near the door. The area of the floor surface below the opening of the floor plate may be cut during use such that an opening that is formed in the floor surface that can receive the bottom edge (and some portion of the side edges) of the plate. This prevents the door from being easily kicked in, as the plate reinforces the door and the floor plate and guide rail prevents the plate (and door) from moving.

The present invention is also comprised of a method of using the device. First, a device is provided comprised of at least one plate, at least one guide rail comprised of at least one plate opening, and a floor plate comprised of at least one opening. Then, the guide rail can be secured to a door via at least one fastener. Then, the floor plate can be secured via at least one fastener to the floor surface near the door. Then, the plate can be dropped into the opening of the guide rail from above the rail such that the plate falls into the rail and is captured by the opening of the floor plate. When a user desires to remove the plate, the plate can be pulled upwards from the opening via a top edge.

In a second method of using the device, a device is provided comprised of at least one plate, at least one guide rail comprised of at least one plate opening, and a floor plate comprised of at least one opening. Then, the guide rail can be secured to a door via at least one fastener. Then, the floor plate can be secured via at least one fastener to the floor surface near the door, wherein an area of the floor surface below the opening of the plate is further cut to receive the plate. Then, the plate can be dropped into the opening of the guide rail from above the rail such that the plate falls into the rail and is captured by the opening of the floor plate. When a user desires to remove the plate, the plate can be pulled upwards from the opening via a top edge.

Accordingly, the door barrier device of the present invention is particularly advantageous as it provides a device that increases the strength of a door. More specifically, the device prevents a door from being easily kicked in. In addition, the device also prevents a bullet from penetrating a door. Further, the device can be universally installed on any door via the guide rails. In this manner, the door barrier device overcomes the limitations of existing doors known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a front view of one potential embodiment of a door barrier device of the present invention while the guide rail is attached to a door and the plate is received by the guide rail and floor plate (in an embodiment wherein an opening has been cut in a floor surface below the opening of the floor plate) in accordance with the disclosed architecture;

FIG. 2 illustrates a perspective view of a guide rail receiving a plate of one potential embodiment of a door barrier device of the present invention and in accordance with the disclosed architecture;

FIG. 3 illustrates a perspective view of a floor plate receiving a plate of one potential embodiment of a door barrier device of the present invention (in an embodiment wherein an opening has been cut in a floor surface below the opening of the floor plate) in accordance with the disclosed architecture;

FIG. 4 illustrates a flowchart of a method of using one potential embodiment of a door barrier device of the present invention in accordance with the disclosed architecture; and

FIG. 5 illustrates a flowchart of a method of using one potential embodiment of a door barrier device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a device that increases the strength of a door. More specifically, there exists a long-felt need in the art for a door barrier device. There also exists a long-felt need in the art for a door barrier device that strengthens a door and prevents it from being easily kicked in. In addition, there exists a long-felt need in the art for a door barrier device that prevents a bullet from penetrating a door. Further, there exists a long-felt need in the art for a door barrier device that strengthens a door and prevents the door from being easily kicked in and prevents a bullet from penetrating a door, wherein the device can be applied to any door.

The present invention, in one exemplary embodiment, is comprised of a door barrier device comprised of at least one plate that attaches to a door via at least one guide rail. The bottom edge of the plate is also received by at least one floor plate mounted within the floor surface near the door. The plate further falls into an opening of the plate and into the floor surface such that a portion of the plate is secured in the surface. As a result, the door is reinforced and cannot be easily opened with the plate in place.

The plate is preferably made from a metal material such as but not limited to 14 gauge steel and/or may be made from a bulletproof material. The plate is received by at least one guide rail that attaches to a front or rear surface of a door. The rail is comprised of at least one plate opening that preferably runs the duration of the rail and begins on the top wall of the rail. As a result, the side edges of the plate can be placed through the opening from above to allow the plate to slide into the rail. To prevent the plate from sliding completely through the rail, the top edge of the plate is comprised of at least one 90-degree angle that forms a lip.

After the plate is positioned in the mounting opening of the guide rail, the bottom edge (and some portion of the side edges) may be received by at least one opening of at least one floor plate. The floor plate is preferably positioned below the opening of the rail. The plate is preferably installed in a recessed manner within the floor surface near the door. The area of the floor surface below the opening of the floor plate may be cut during use such that an opening that is formed in the floor surface that can receive the bottom edge (and some portion of the side edges) of the plate. This prevents the door from being easily kicked in, as the plate reinforces the door and the floor plate and guide rail prevents the plate (and door) from moving.

The present invention is also comprised of a method of using the device. First, a device is provided comprised of at least one plate, at least one guide rail comprised of at least one plate opening, and a floor plate comprised of at least one opening. Then, the guide rail can be secured to a door via at least one fastener. Then, the floor plate can be secured via at least one fastener to the floor surface near the door. Then, the plate can be dropped into the opening of the guide rail from above the rail such that the plate falls into the rail and is captured by the opening of the floor plate. When a user desires to remove the plate, the plate can be pulled upwards from the opening via a top edge.

In a second method of using the device, a device is provided comprised of at least one plate, at least one guide rail comprised of at least one plate opening, and a floor plate comprised of at least one opening. Then, the guide rail can be secured to a door via at least one fastener. Then, the floor plate can be secured via at least one fastener to the floor surface near the door, wherein an area of the floor surface below the opening of the plate is further cut to receive the plate. Then, the plate can be dropped into the opening of the guide rail from above the rail such that the plate falls into the rail and is captured by the opening of the floor plate. When a user desires to remove the plate, the plate can be pulled upwards from the opening via a top edge.

Accordingly, the door barrier device of the present invention is particularly advantageous as it provides a device that increases the strength of a door. More specifically, the device prevents a door from being easily kicked in. In addition, the device also prevents a bullet from penetrating a door. Further, the device can be universally installed on any door via the guide rails. In this manner, the door barrier device overcomes the limitations of existing doors known in the art.

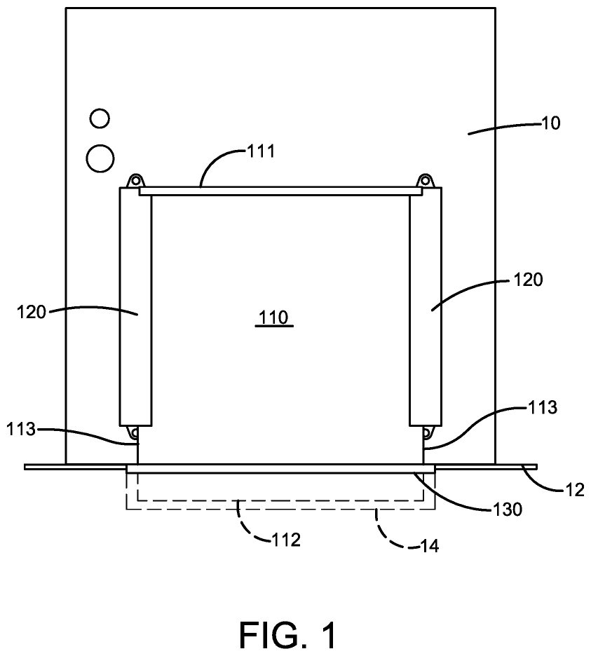

Referring initially to the drawings, FIG. 1 illustrates a front view of one potential embodiment of a door barrier device 100 of the present invention while the guide rail 120 is attached to a door 100 and the plate 110 is received by the guide rail 120 and floor plate 130 (in an embodiment wherein an opening 14 has been cut in a floor surface 12 below the opening 132 of the floor plate 130) in accordance with the disclosed architecture. The device 100 is comprised of at least one plate 110 that attaches to a door 10 via at least one guide rail 120. The bottom edge 112 of the plate 110 is also received by at least one floor plate 130 mounted within the floor surface 12 near the door 10. The plate 110 further falls into an opening 132 of the plate 130 and into the floor surface such that a portion of the plate 110 is secured in the surface 12. As a result, the door 10 is reinforced and cannot be easily opened with the plate 110 in place.

The plate 110 is preferably rectangular or square in shape but may be any shape. The plate 110 is preferably made from a metal material such as but not limited to 14 gauge steel. In one embodiment, the plate 110 may be made from a bulletproof material.

The plate 110 is received by at least one guide rail 120. The rail 120 attaches to a front or rear surface of a door 10 via at least one mounting bracket 124. More specifically, the mounting bracket 124 has at least one opening 126. At least one fastener 128 such as but not limited to a screw, a bolt, etc. can be placed through the opening 126 and into the door 10.

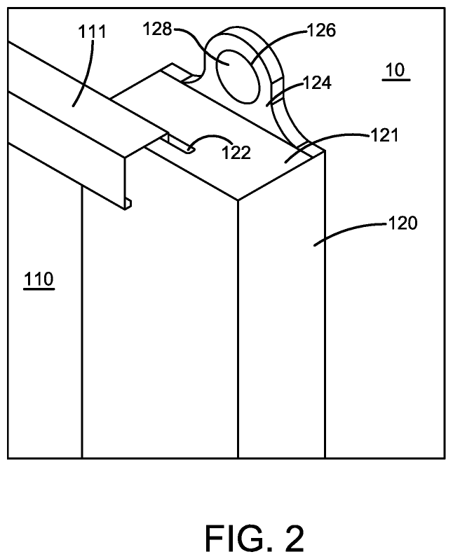

The rail 120 is comprised of at least one plate opening 122. The opening 122 preferably runs the duration of the rail 120 and begins on the top wall 121 of the rail 120. However, the opening 122 may be positioned anywhere on the rail 120 in different embodiments. As a result, the side edges 113 of the plate 110 can be placed through the opening 126 from above to allow the plate 110 to slide into the rail 120. To prevent the plate 110 from sliding completely through the rail 120, the top edge 111 of the plate 110 is comprised of at least one 90-degree angle that forms a lip, as seen in FIG. 2. In various embodiments, the angle and shape of the top edge 111 may vary in shape and degree, so long as the edge 11 is shaped such that the edge 111 prevents the plate 110 from falling completely through the opening 122. In this manner, the top edge 111 catches on the guide rail 120. The edge 111 also allows a user to easily grab the plate 110 and pull it upwards to remove it from the guide rail 120.

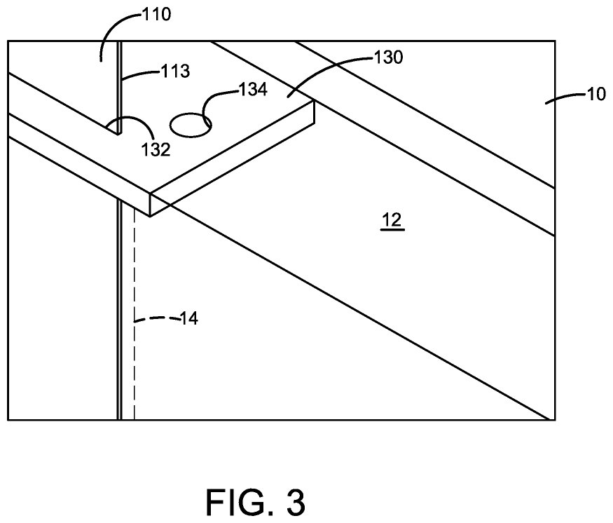

After the plate 110 is positioned in the mounting opening 122 of the guide rail 120, the bottom edge 112 (and some portion of the side edges 113) may be received by at least one opening 132 of at least one floor plate 130, as seen in FIG. 3. The floor plate 130 is preferably rectangular and is positioned below the opening 122 of the rail 120. The plate 130 is preferably installed in a recessed manner within the floor surface 12 near the door 10. The plate 130 may be further secured into said floor surface 12 via at least one fastener 128 such as but not limited to a screw or a bolt, that can be placed through the opening 134 and into the floor surface 12.

The area of the floor surface 12 below the opening 132 of the floor plate 130 may be cut during use such that an opening 14 that is formed in the floor surface 12 that can receive the bottom edge 112 (and some portion of the side edges 113) of the plate 110, as seen in FIG. 1. This prevents the door 10 from being easily kicked in, as the plate 110 reinforces the door and the floor plate 130 and guide rail 120 prevents the plate 110 (and door 10) from moving.

In one embodiment, the opening 132 of the plate 130 may not allow the plate 110 to completely pass through the floor plate 130. Instead, the plate 110 will be captured within the floor plate 130. This embodiment eliminates the need to cut the floor surface 12.

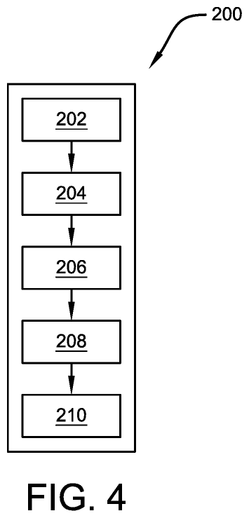

The present invention is also comprised of a method of using 200 the device 100, as seen in FIG. 4. First, a device 100 is provided comprised of at least one plate 110, at least one guide rail 120 comprised of at least one plate opening 122, and a floor plate 130 comprised of at least one opening 132 [Step 202]. Then, the guide rail 120 can be secured to a door 10 via at least one fastener 128 [Step 204]. Then, the floor plate 130 can be secured via at least one fastener 128 to the floor surface 12 near the door 10 [Step 206]. Then, the plate 110 can be dropped into the opening 122 of the guide rail 120 from above the rail 120 such that the plate 110 falls into the rail 120 and is captured by the opening 132 of the floor plate 130 [Step 208]. When a user desires to remove the plate 110, the plate 110 can be pulled upwards from the opening 122 via a top edge 111 [Step 210].

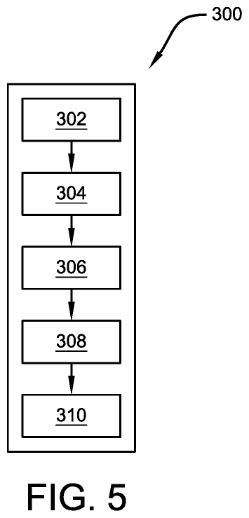

The present invention is also comprised of a method of using 300 the device 100, as seen in FIG. 5. First, a device 100 is provided comprised of at least one plate 110, at least one guide rail 120 comprised of at least one plate opening 122, and a floor plate 130 comprised of at least one opening 132 [Step 302]. Then, the guide rail 120 can be secured to a door 10 via at least one fastener 128 [Step 304]. Then, the floor plate 130 can be secured via at least one fastener 128 to the floor surface 12 near the door 10, wherein an area of the floor surface 12 below the opening 132 of the plate 130 is further cut to receive the plate [Step 306]. Then, the plate 110 can be dropped into the opening 122 of the guide rail 120 from above the rail 120 such that the plate 110 falls into the rail 120 and is captured by the opening 132 of the floor plate 130 [Step 308]. When a user desires to remove the plate 110, the plate 110 can be pulled upwards from the opening 122 via a top edge 111 [Step 310].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “door barrier device” and “device” are interchangeable and refer to the door barrier device 100 of the present invention.

Notwithstanding the forgoing, the door barrier device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the door barrier device 100 as shown in the FIGS. are for illustrative purposes only, and that many other sizes and shapes of the door barrier device 100 are well within the scope of the present disclosure. Although the dimensions of the door barrier device 100 are important design parameters for user convenience, the door barrier device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A door barrier device comprising:
a guide rail comprised of a first opening;
a plate; and
a floor plate comprised of a second opening.

2. The door barrier device of claim 1, wherein the plate is comprised of a square or a rectangular plate.

3. The door barrier device of claim 1, wherein the plate is comprised of a steel material.

4. The door barrier device of claim 1, wherein the plate is comprised of a bulletproof material.

5. The door barrier device of claim 1, wherein the plate is received by the first opening.

6. The door barrier device of claim 1, wherein the plate is received by the second opening.

7. The door barrier device of claim 5, wherein the first opening is positioned on a top wall of the guide rail.

8. The door barrier device of claim 7, wherein the first opening runs the duration of the guide rail.

9. A door barrier device comprising:
a guide rail comprised of an opening and a mounting bracket;
a plate comprised of a top edge having a 90-degree angle;
a floor plate comprised of an opening.

10. The door barrier device of claim 9, wherein the mounting bracket is comprised of an opening.

11. The door barrier device of claim 9, wherein the plate is received by the first opening.

12. The door barrier device of claim 9, wherein the plate is received by the second opening.

13. The door barrier device of claim 9, wherein the floor plate is positioned underneath the guide rail.

14. The door barrier device of claim 9, wherein the first opening is positioned on a top wall of the guide rail.

15. The door barrier device of claim 14, wherein the first opening runs the duration of the guide rail.

16. A method of using a door barrier device, the method comprising the following steps:
providing a door barrier device comprised of a plate, a guide rail comprised of a first opening; and a floor plate comprised of a second opening;
securing the guide rail to a door via a first fastener;
securing the floor plate to a floor surface below the guide rail via a second fastener; and
placing the plate through the first opening such that it is captured by the first opening and second opening.

17. The method of using a door barrier device of claim 16 further comprised of a step of creating an opening in the floor surface below the second opening.

18. The method of using a door barrier device of claim 16, wherein the plate is comprised of a top edge.

19. The method of using a door barrier device of claim 18, wherein the top edge is comprised of a 90-degree lip.

20. The method of using a door barrier device of claim 16, wherein the plate is comprised of a steel material.
